(19) United States
(12) Patent Application Publication
(10) Pub. No.: US 2011/0054902 A1
(43) Pub. Date: Mar. 3, 2011

(54) SINGING VOICE SYNTHESIS SYSTEM, METHOD, AND APPARATUS

(76) Inventors: Hsing-Ji LI, Xindian City (TW); Hong-Ru Lee, Hsinchu City (TW); Wen-Nan Wang, Qingshui Township (TW); Chih-Hao Hsu, Taipei City (TW); Jyh-Shing Jang, Taipei City (TW)

(21) Appl. No.: 12/625,834

(22) Filed: Nov. 25, 2009

(30) Foreign Application Priority Data
Aug. 25, 2009 (TW) 098128479

(51) Int. Cl. G10L 13/00

(52) U.S. Cl. 704/258; 704/E19.001

(57) ABSTRACT

A singing voice synthesis system is provided. The storage unit stores at least one tune. The tempo unit provides a set of tempo cues in accordance with a selected tune from the at least one tune. The input unit receives a plurality of original voice signals corresponding to the selected tune. The processing unit processes the original voice signals and generates a synthesized singing voice signal according to the selected tune.

### BACKGROUND OF THE INVENTION

1. Field of the Invention

The invention generally relates to the synthesis of singing voices, and more particularly, to singing voice synthesis system, method, and apparatus capable of generating a synthesized singing voice with personal tones.

2. Description of the Related Art

In recent years, the processing capability of electronic computing devices has improved substantially. Accordingly, applications thereof have also increased. One such example may be seen in speech/singing voice synthesis systems. In general, speech/singing voice synthesis refers to artificially generating pseudo human voices. There are already many related products commercially available, including the virtual singer software, electronic pets, the singing tutor software/systems, and software for virtually combining melodies as a composer and singer.

For the conventional singing voice synthesis system, as shown in FIG. 1, a corpus database 20 must be established first by recording a large amount of human speeches, so as to build the mapping relation between the words and the speeches. A corpus database 20 can be classified into a single-syllable-based corpus 21, such as “da”, “ta”, and “base” in the word “database”, a coarticulation-based corpus 22, such as the word “database”, and a song-based corpus 23.

FIG. 1 is a diagram illustrating procedure steps of the conventional singing voice synthesis system. To begin, the MIDI (Musical Instrument Digital Interface) file and the lyrics of the selected song is input to the singing voice synthesis system. The MIDI file includes the score of the selected song, consisting of information containing tempo and notes. In step S101, the words of the selected song are segmented according to the MIDI file and the lyrics to obtain phonetic labels. In step S102, for each word segmented from the selected song, a corpus that matches the word is searched for from the corpus database 20. Later in step S103, the duration and pitch of the voice signals to the matched corpuses are adjusted. At last, in step S104, the voice signals are smoothed, concatenated, and added echo effect and accompaniment for generation of the synthesized singing voice. Nevertheless, the conventional singing voice synthesis system has disadvantages, such as: (1) a time-consuming nature due to the establishment of the corpus database, and large memory space occupancy for storing the corpus database; (2) a complex searching procedure for determining the matching corpus, which often occupies a lot of system resources (note that often, errors in matching may occur, causing problems for the subsequent processes); (3) poor results when applied to different languages, such as Chinese, wherein the results are mechanical, rigid and non-human like; (4) limitations of tones to those located in the corpus database and requirement to re-establish the corpus database every time the tone of the synthesized singing voice requires adjustment; and (5) a complex process requiring an extended amount of time to generate a synthesized singing voice. Therefore, the conventional singing voice synthesis system does not meet user requirements in terms of cost, efficiency, and quality.

### BRIEF SUMMARY OF THE INVENTION

Accordingly, embodiments of the invention provide a singing voice synthesis system, method, and apparatus for a user to generate a synthesized singing voice with personal tones. The user does not have to be skilled with music theory, and is just required to intuitively input the voice signals by reading or singing the lyrics according to the tempo cues.

In one aspect of the invention, a singing voice synthesis system is provided. The singing voice synthesis system comprises a storage unit, a tempo unit, an input unit, and a processing unit. The storage unit stores at least one tune. The tempo unit provides a set of tempo cues in accordance with a selected tune from the at least one tune. The input unit receives a plurality of original voice signals corresponding to the selected tune. The processing unit processes the original voice signals and generates a synthesized singing voice signal according to the selected tune.

In another aspect of the invention, a singing voice synthesis method for an electronic computing device with an audio receiver and an audio speaker is provided. The method comprises providing a set of tempo cues in accordance with a selected tune from the at least one tune, receiving, via the audio receiver, a plurality of original voice signals corresponding to the selected tune, processing the original voice signals according to the selected tune, and outputting, via the audio speaker, a synthesized singing voice signal.

In another aspect of the invention, a singing voice synthesis apparatus is provided. The singing voice synthesis apparatus comprises an exterior case, a storage device, a tempo means, an audio receiver, and a processor. The storage device, installed inside of the exterior case and connected to the processor, stores at least one tune. The tempo means, installed outside of the exterior case and connected to the processor, provides a set of tempo cues in accordance with a selected tune from the at least one tune. The audio receiver, installed outside of the exterior case and connected to the processor, receives a plurality of original voice signals corresponding to the selected tune. The processor, installed inside of the exterior case, processes the original voice signals and generates a synthesized singing voice signal according to the selected tune.

Other aspects and features of the present invention will become apparent to those ordinarily skilled in the art upon review of the following descriptions of specific embodiments of the singing voice synthesis systems, methods, and apparatuses.

### BRIEF DESCRIPTION OF DRAWINGS

The invention can be more fully understood by reading the subsequent detailed description and examples with references made to the accompanying drawings, wherein:

FIG. 1 is a diagram illustrating procedure steps of the conventional singing voice synthesis system;

FIG. 2 is a block diagram illustrating a singing voice synthesis system in accordance with an embodiment of the present invention;

FIG. 3 is a diagram illustrating the determination of rhythm error in accordance with an embodiment of the present invention;

FIG. 4 is a diagram illustrating the pitch adjustment procedure using the PSOLA method in accordance with an embodiment of the present invention;

FIG. 5 is a diagram illustrating the pitch adjustment procedure using the Cross-Fadding method in accordance with an embodiment of the present invention;

FIGS. 6A and 6B are diagrams illustrating the pitch adjustment procedure using the Resample method in accordance with an embodiment of the present invention;

FIG. 7A-7C are diagrams illustrating the smoothing procedure using the polynomial interpolation with cubic, quartic, and quintic Bézier curves in accordance with an embodiment of the present invention;

FIG. 8 is a flow chart illustrating the singing voice synthesis method in accordance with an embodiment of the present invention;

FIG. 9A˜9D are flow charts illustrating the singing voice synthesis methods in accordance with some embodiments of the present invention; and

FIG. 10 is a diagram illustrating the system architecture of the singing voice synthesis apparatus in accordance with an embodiment of the present invention.

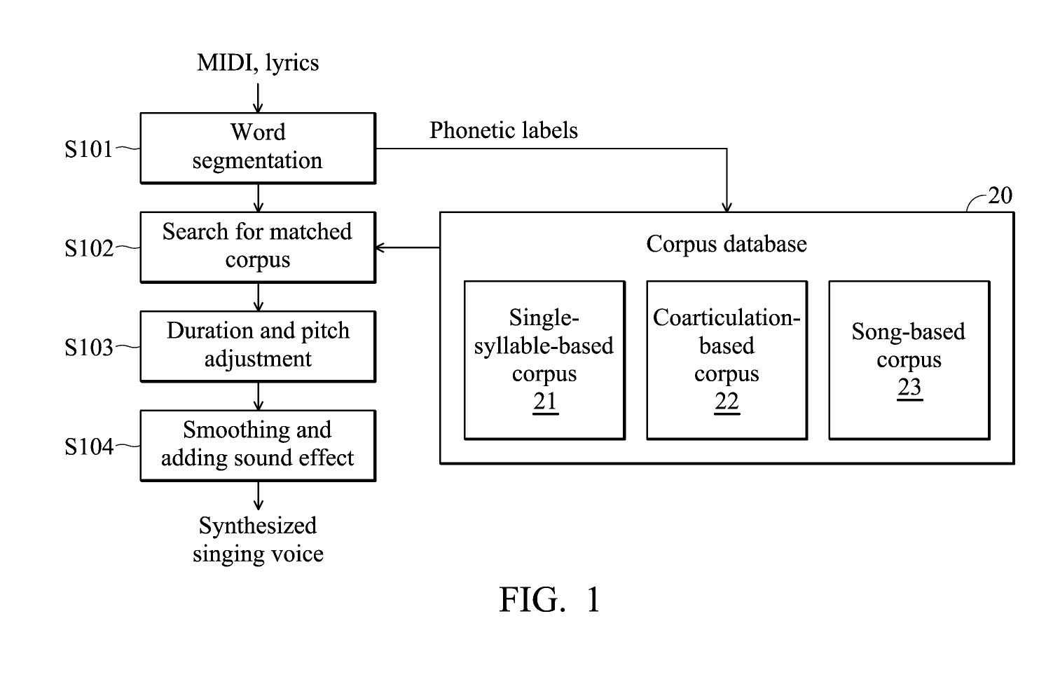

### DETAILED DESCRIPTION OF THE INVENTION

The following description is made for the purpose of illustrating the general principles and features of the invention, and should not be taken in a limiting sense. The scope of the invention is best determined by reference to the appended claims. In order to give better examples, the preferred embodiments are given below accompanied with the drawings.

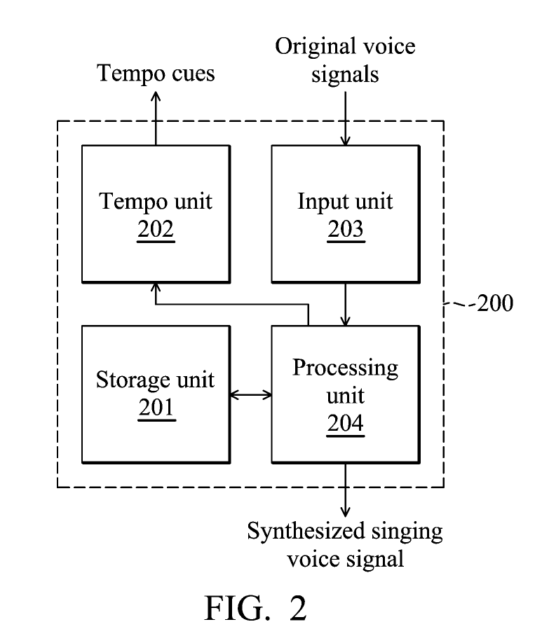

FIG. 2 is a block diagram illustrating a singing voice synthesis system in accordance with an embodiment of the present invention. The singing voice synthesis system 200 includes a storage unit 201, a tempo unit 202, an input unit 203, and a processing unit 204. The storage unit 201 stores the tunes of a plurality of songs. When synthesizing a singing voice for a selected song, the storage unit 201 provides the tune of the selected song to the tempo unit 202. The tempo unit 202 then provides a set of tempo cues in accordance with the selected tune, to assist the user in generating a plurality of voice signals by either reading lyrics aloud or singing the lyrics. The set of tempo cues generally refers to the beats of the selected tune. Subsequently, the input unit 203 receives the voice signals from the user. The voice signals generated by the user are referred to as the original voice signals herein, and they correspond to the selected tune and the set of tempo cues. Lastly, the processing unit 204 processes the original voice signals according to the selected tune, and generates a synthesized singing voice signal.

In some embodiments, the selected tune may be a WAV (Waveform Audio) file for the tempo unit 202 to mark out the beats of the selected song by the beat tracking technique. Also, in other embodiments, the selected tune may be a MIDI file for the tempo unit 202 to retrieve the beats of the selected song by acquiring the tempo events in the MIDI file. The provision of the set of tempo cues from the tempo unit 202 may be implemented in a variety of ways, such as: visual sign (for example, moving symbol, flashing symbol, leaping dot, or color-changing pattern, etc.) generated by a display, audio signals (for example, the ticking sound of a metronome) generated by an audio speaker, actions (for example, swinging, rotating, leaping, or the waving axis of a metronome, etc.) performed by a movable machinery, or flashes and color changing lights generated by a light emitting unit.

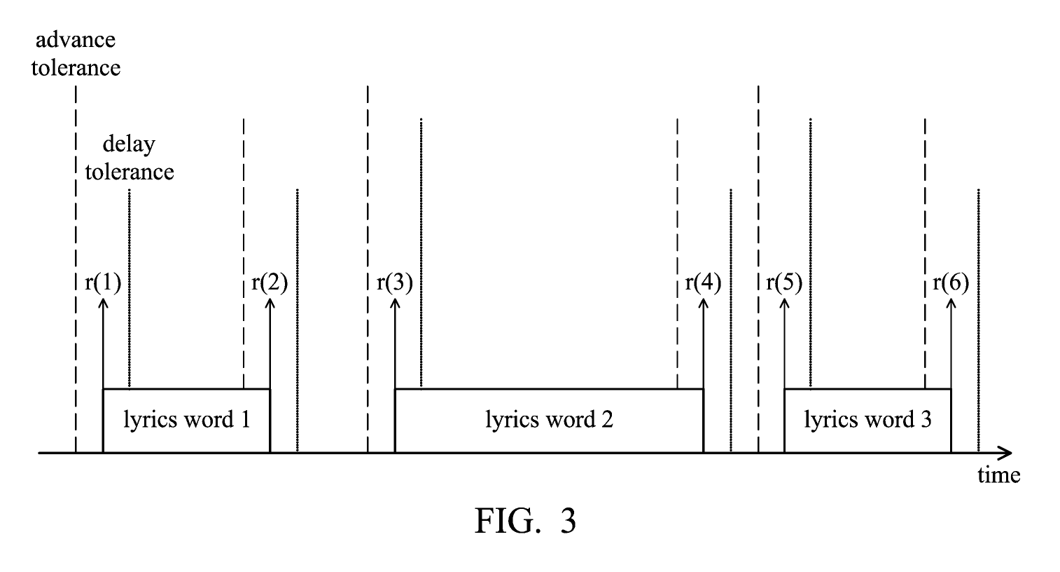

In order to make sure the established rhythm pattern of the original voice signals is within an acceptable level, in some embodiments, a rhythm analysis unit (not shown) determines whether the established rhythm pattern exceeds a default error threshold value. The established rhythm pattern refers to accuracy (slow or fast) of each word of the lyrics being read or sung, when corresponding to the selected tune. If the established rhythm pattern exceeds the default error threshold value, the rhythm analysis unit (not shown) prompts the user to regenerate the original voice signals and the receiving procedure of the original voice signals is repeated. The determination of whether the established rhythm pattern exceeds the default error threshold value will be described in detail later with reference to FIG. 3. Meanwhile, in other embodiments, the rhythm analysis unit (not shown) may be designed to output the original voice signals for the user to listen to and determine whether the original voice signals are acceptable. If the original voice signals are not acceptable, the rhythm analysis unit (not shown) further provides an operation interface for the user to select the option of regenerating the original voice signals. In other embodiments, the user may generate the original voice signals by singing the lyrics, or input prerecorded/pre-processed voice signals to be the original voice signals.

The processing of the original voice signals includes, in some embodiments, flatting all the pitches of the original voice signals to a specific pitch level, and adjusting each of the flatted pitches to its standard pitch indicated by the selected tune to obtain a plurality of adjusted voice signals. The processing of the original voice signals further includes smoothing the adjusted voice signals into a smoothed voice signal. The details are given in the embodiments as follows.

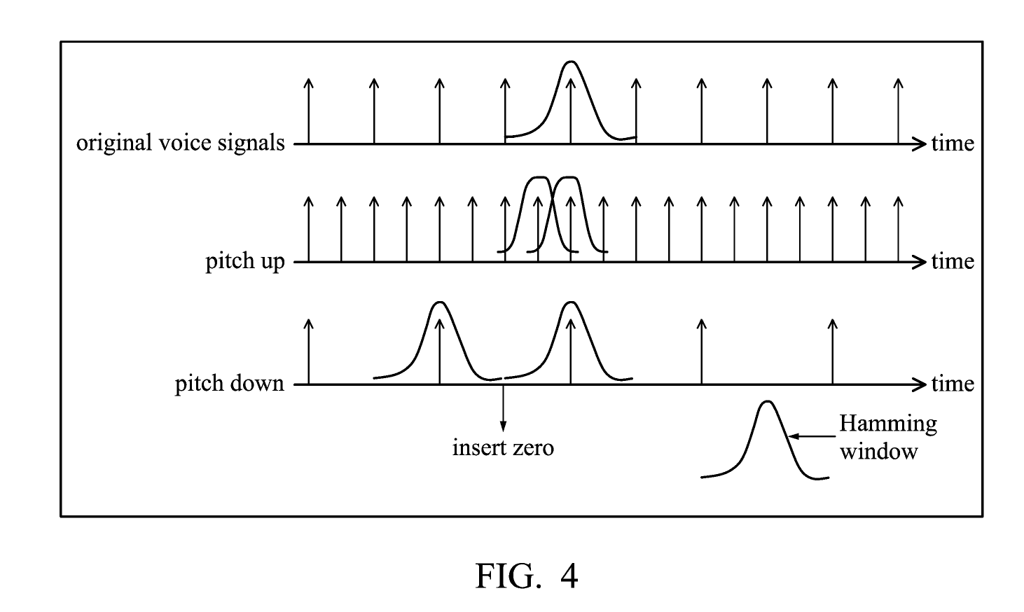

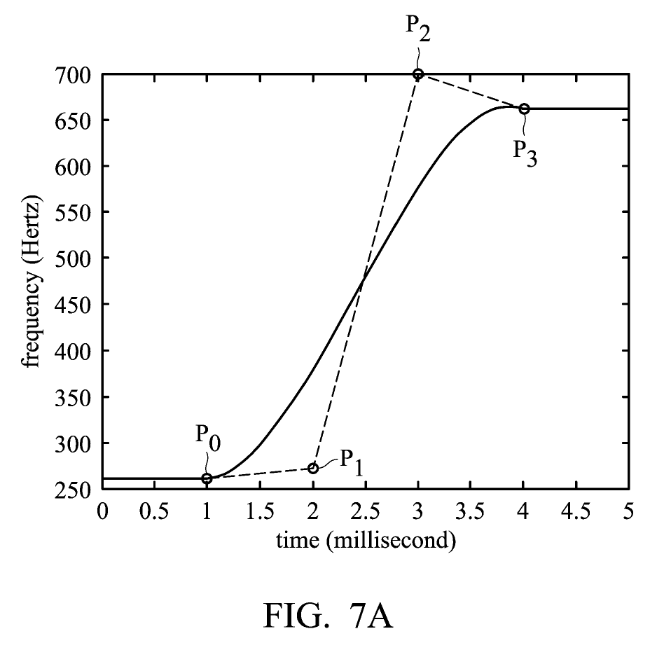

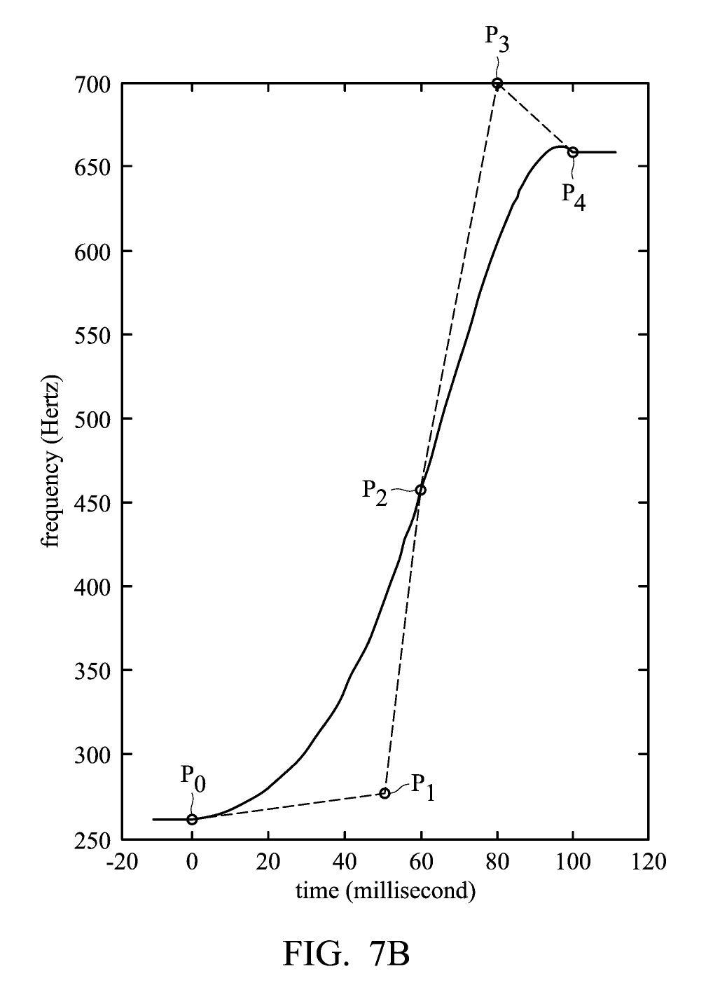

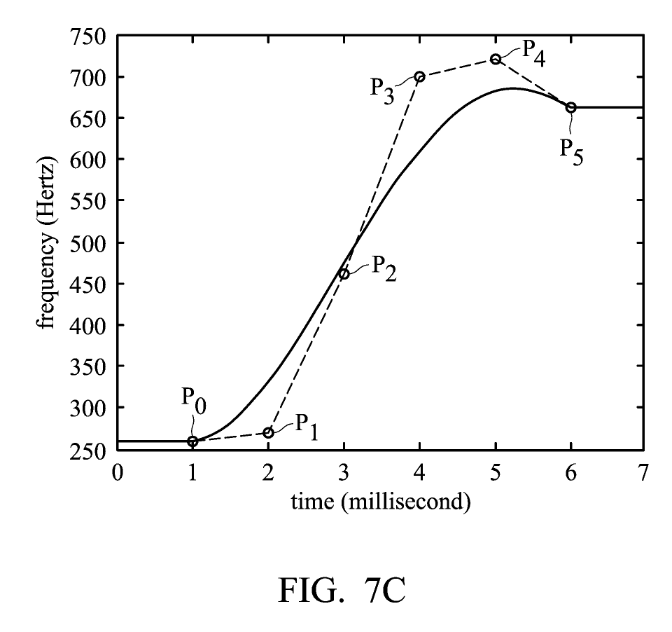

In some embodiments, the processing unit 204 may perform a pitch analysis procedure to flat the pitches of the original voice signals by the pitch tracking and pitch marking techniques, and obtain a plurality of same pitches as a result. Next, the processing unit 204 may perform a pitch adjustment procedure, for instance, the PSOLA (Pitch Synchronous OverLap-Add) method, the Cross-Fadding method, or the Resample method, on the same pitches, to adjust each of the same pitches to its standard pitch indicated by the tune of the selected song, and obtain a plurality of adjusted voice signals. The detailed operation of the PSOLA (Pitch Synchronous OverLap-Add) method, Cross-Fadding method, and Resample method will be described later with reference to FIGS. 4, 5, 6A and 6B, respectively. The processing unit 204 then performs a smoothing procedure, for instance, linear interpolation, bilinear interpolation, or polynomial interpolation, to smoothly concatenate the adjusted voice signals to obtain a smoothed voice signal. The detailed operation of the polynomial interpolation procedure will be further illustrated with reference to FIG. 7A˜7C.

In other embodiments, the processing unit 204 further performs a sound effect procedure on the smoothed voice signal. The sound effect procedure may first determine the size of the sampling frame to the smoothed voice signal based on the loading of the singing voice synthesis system 200. Then, the sound effect procedure continues by adjusting the volume and adding vibrato and echo effects to the smoothed voice signal, one sampling frame at a time, and consequently, a sound-effected voice signal is obtained. The processing unit 204 may choose one of the adjusted voice signals, the smoothed voice signal, and the sound-effected voice signal, to be the input to an accompaniment procedure. The accompaniment procedure combines the chosen voice signal(s) with the accompaniment of the selected song and generates an accompanied voice signal. It is noted that each of the previously mentioned adjusted voice signals, smoothed voice signal, sound-effected voice signal, and accompanied voice signal may be the presentation of a synthesized singing voice signal of the present invention. The synthesized singing voice signal may be an electronic file having a plurality of voice signals, such as the adjusted voice signals, the smoothed voice signal, the sound-effected voice signal, or the accompanied voice signal. In some other embodiments, the singing voice synthesis system 200 further includes an output unit for outputting the synthesized singing voice signal. The output unit may be connected to the tempo unit 202 or any other display unit (not shown), so that when outputting the synthesized singing voice signal, the output unit can utilize the tempo unit 202 or the display unit to show the beats in the form of the previously mentioned actions, such as visual signals such as moving symbols, flashing symbols, leaping dots, or color-changing patterns or swinging, rotating, leaping, or the waving axis of a metronome or flashes or color changing lights or audio signals such as the ticking sound of a metronome.

FIG. 3 is a diagram illustrating the determination of rhythm error in accordance with an embodiment of the present invention. In FIG. 3, a section of the lyrics of the selected song includes three lyrics: lyrics word 1, lyrics word 2, and lyrics word 3. In some embodiments, the storage unit 201 may further store the lyrics of the selected song, and the rhythm corresponding to the lyrics. The rhythm analysis unit (not shown) obtains the standard beat points r(i) according to the tune of the selected song. For example, r(1) and r(2), r(3) and r(4), and r(5) and r(6), represent the end points of the time periods relating to lyrics word 1, lyrics word 2, and lyrics word 3 of the lyrics, respectively. The dashed lines before each time period represent the advanced tolerance of the received voice signal and the dotted lines after represent the delayed tolerance of the received voice signal. The time interval between the dashed lines and the dotted lines is the default error threshold value μ. Since the original voice signals are in a established rhythm pattern, denoted as c(i), the accumulated error value can be expressed with the following function:

$$P ( j ) = {\sum }_{i = -}^{n} \vert r ( i ) - c ( j ) \vert , j = 1 \sim 3 \qquad ( 1 )$$

wherein j represents the word number. If the result of function (1) exceeds the default error threshold value μ, then the step of receiving the original voice signals is repeated.

FIG. 4 is a diagram illustrating the pitch adjustment procedure using the PSOLA method in accordance with an embodiment of the present invention. The sub-drawing at the top in FIG. 4 represents the original voice signals. The arrows represent the marked pitches. In this embodiment, the standard pitches are twice the marked pitches so the distances between each of the marked pitches are reduced by half. Otherwise, if the standard pitches are half the marked pitches, then the distances between each of the marked pitches are increased by twice. Subsequently, Hamming windows are used for every two adjacent pitches to re-model the voice signals. The Hamming windows can be calculated with the following function:

$$W ( m ) = 0.54 - 0.46 \times cos ( \frac{2 π m}{N - 1} ) , 0 \leq m \leq N \qquad ( 2 )$$

wherein N represents the time length of the sampling process, and in represents the time points within the sampling range. After obtaining the Hamming windows, the PSOLA method continues by overlapping the voice signals re-modeled by the Hamming windows to form new voice signals, which are the previously mentioned adjusted voice signals.

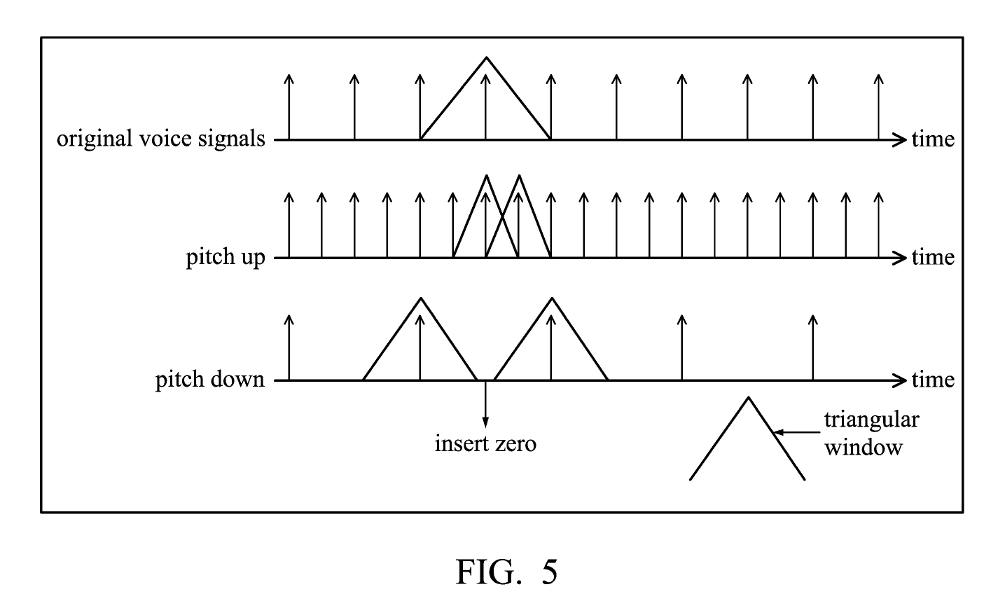

FIG. 5 is a diagram illustrating the pitch adjustment procedure using the Cross-Fadding method in accordance with an embodiment of the present invention. The Cross-Fadding method is similar to the PSOLA method, with the exception that it takes less computing time and has less smoothed result. The advantage of the Cross-Fadding method is that it adjusts the pitch more easily. Triangular windows, instead of the Hamming windows, are used to perform the voice signals re-modeling process. After obtaining the adjusted pitches, the Cross-Fadding method continues by calculating the inner product of the adjusted pitches and the triangular windows, and the adjusted voice signals are generated.

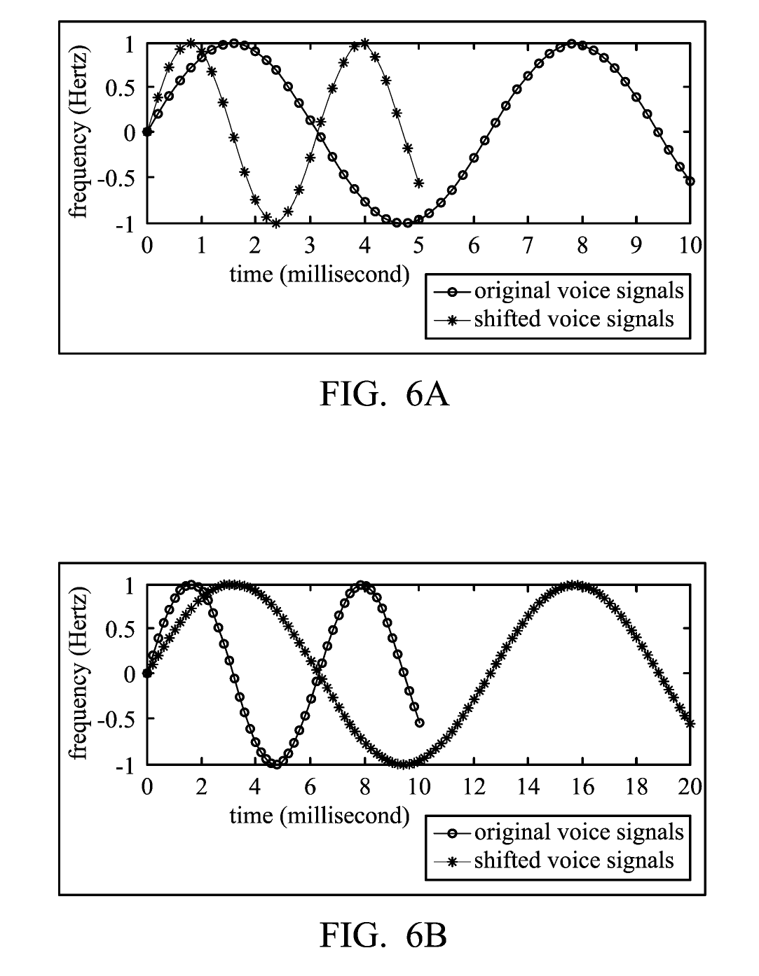

FIGS. 6A and 6B are diagrams illustrating the pitch adjustment procedure using the Resample method in accordance with an embodiment of the present invention. The Resample method in FIG. 6A shifts the pitches of the original voice signals up to twice their level by the down sampling process, according to the tune of the selected song. On the other hand, The Resample method in FIG. 6B shifts the pitches of the original voice signals down to half their level by the up sampling process.

In regards to singing from a low pitch to a high pitch, unlike computer generated voices, where pitches jump from the low to high pitch, for the human voice, often a slightly higher pitch than the high pitch is reached before gliding to the high pitch; especially when the pitch difference between the two pitches is large. In order to simulate this feature of human voices, one embodiment of the present invention uses the Bézier curve to implement the smoothing procedure. Take the cubic Bézier curve for example, four control points are given as shown in FIG. 7A, denoted as P₀, P₁, P₂, and P₃. The relationship between the control points can be expressed with the following function:

$$δ = 1 - exp ( \frac{- \vert {P}_{3} - {P}_{0} \vert}{100} ) \\ {P}_{y - 1} = {P}_{y} \pm {P}_{y} ( \sqrt[12]{2} - 1 ) \times δ , 1 \leq y \leq 3 \qquad ( 3 )$$

wherein δ represents a parameter, which increases in accordance with the variation of the pitches, and its value is between 0 and 1 and [symbol] 2 is the ratio of the halftones of the scale of the twelve-tone equal temperament. The operator “±”, uses “+” to represent moving from a low pitch to a high pitch, and “−” to represent moving from a high pitch to a low pitch. In FIG. 7A, the control point P₀ is set as the initial pitch, the control point P₃ is set as the target pitch, the control point P₂ is set to 2 milliseconds after the control point Pₒ, and control point P₁ is set to 1 milliseconds before the control point P₂. The cubic Bézier curve can be derived by solving the following function (3):

B(t)=P₀(1−t)³+3P₁t(1−t)²+3P₂t²(1−t)+P₃t³, tε[0,1] (4)

In another embodiment, a quartic Bézier curve is used to implement the smoothing procedure. The relationship between the five control points, P₀, P₁, P₂, P₃, and P₄, can be expressed with the following function:

$$δ = 1 - exp ( \frac{- \vert {P}_{4} - {P}_{0} \vert}{100} ) \\ {P}_{y - 1} = {P}_{y} \pm {P}_{y} ( \sqrt[12]{2} - 1 ) \times δ , 1 \leq y \leq 4 \qquad ( 5 )$$

wherein δ represents a parameter, which increases in accordance with the variation of the pitches, and its value is between 0 and 1 and [symbol] 2 is the ratio of the halftones of the scale of the twelve-tone equal temperament. The operator “±”, uses “+” to represent moving from a low pitch to a high pitch, and “−” to represent moving from a high pitch to a low pitch. In FIG. 7B, the control point P₀ is set as the initial pitch, the control point P₂ is set to 60 milliseconds after the control point P₀, the control point P₁ is set to 10 milliseconds before the control point P₂, the control point P₄ is set to 40 milliseconds after the control point P₂, and control point P₃ is set to 20 milliseconds before the control point P₄. The quartic Bézier curve can be derived by solving the following function (5):

B(t)=P₀(1−t)⁴+4P₁(1−t)³t+6P₂(1−t)²t²+4P₃(1−t)t³+P₄t⁴, tε[0,1] (6)

In another embodiment, a quintic Bézier curve is used to implement the smoothing procedure. The relationship between the six control points, P₀, P₁, P₂, P₃, P₄, and P₅, can be expressed with the following function:

$$δ = 1 - exp ( \frac{- \vert {P}_{5} - {P}_{0} \vert}{100} ) \\ {P}_{y - 1} = {P}_{y} \pm {P}_{y} ( \sqrt[12]{2} - 1 ) \times δ , 1 \leq y \leq 5 \qquad ( 7 )$$

wherein δ represents a parameter, which increases in accordance with the variation of the pitches, and its value is between 0 and 1 and [symbol] 2 is the ratio of the halftones of the scale of the twelve-tone equal temperament. The operator “±”, uses “+” to represent moving from a low pitch to a high pitch, and “−” to represent moving from a high pitch to a low pitch. In FIG. 7C, the control point P₀ is set as the initial pitch, the control point P₅ is set as the target pitch, the control point P₂ is set to 2 milliseconds after the control point P₀, the control point P₁ is set to 1 milliseconds before the control point P₂, the control point P₄ is set to 2 milliseconds after the control point P₂, and control point P₃ is set to 1 milliseconds before the control point P₄. The quintic Bézier curve can be derived by solving the following function (7):

B(t)=P₀(1−t)⁵+5P₁(1−t)⁴t+10P₂(1−t)³t²+10P₃(1−t)²t³+5P₄t⁴(1−t)+P₅t⁵, tε[0,1] (8)

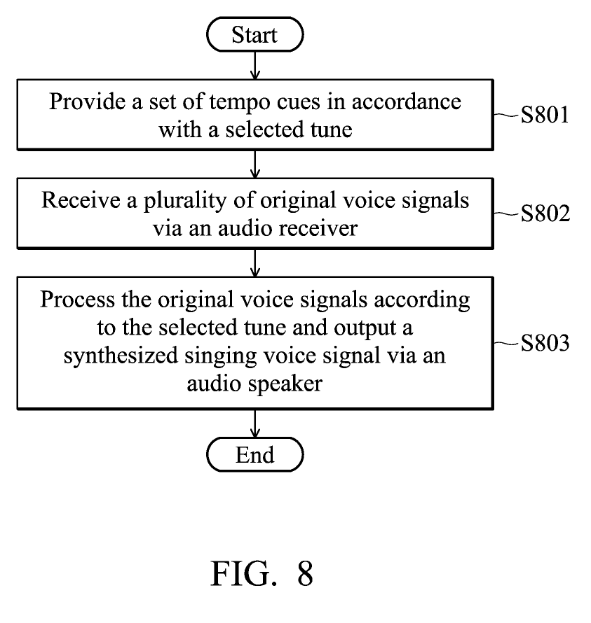

FIG. 8 is a flow chart illustrating the singing voice synthesis method in accordance with an embodiment of the present invention. The singing voice synthesis method is applied in an electronic computing device with an audio receiver and an audio speaker. Firstly, the electronic computing device obtains the tempo of the tune of the selected song, and provides a set of tempo cues to the user (step S801). The user reads lyrics aloud or sings the lyrics according to the set of tempo cues. Secondly, the electronic computing device receives, via the audio receiver, the original voice signals generated by the reading or singing of the user (step S802). It is noted that the original voice signals are generated according to the set of tempo cues. Lastly, the electronic computing device processes the original voice signals according to the tune of the selected song, and generates a synthesized singing voice signal to be outputted via the audio speaker (step S803).

The electronic computing device may include a display unit generating visual signals to be the set of tempo cues, such as: moving symbols, flashing symbols, leaping dots, or color-changing patterns. The electronic computing device may generate audio signals to be the set of tempo cues, and output the audio signals via the audio speaker. The audio signals may be the ticking sound of a metronome. The electronic computing device may include a movable machinery providing actions to be the set of tempo cues, such as: swinging, rotating, leaping, or the waving axis of a metronome. The electronic computing device may include a light emitting unit generating flashes or color changing lights to be the set of tempo cues. In order to make sure the established rhythm pattern of the original voice signals is at an acceptable level, in some embodiments, the singing voice synthesis method may further determine whether the established rhythm pattern exceeds a default error threshold value according to the tune of the selected song. If the established rhythm pattern exceeds the default error threshold value, the singing voice synthesis method continues with prompting the user to regenerate the original voice signals. The detailed operation of determining the established rhythm pattern is shown in FIG. 3. Alternatively, in other embodiments, the singing voice synthesis method may output the original voice signals for the user to listen to and determine whether the original voice signals are acceptable. If the original voice signals are not acceptable, then the user repeats generating of the original voice signals. In either embodiments the user may generate the original voice signals by reading lyrics aloud or singing the lyrics.

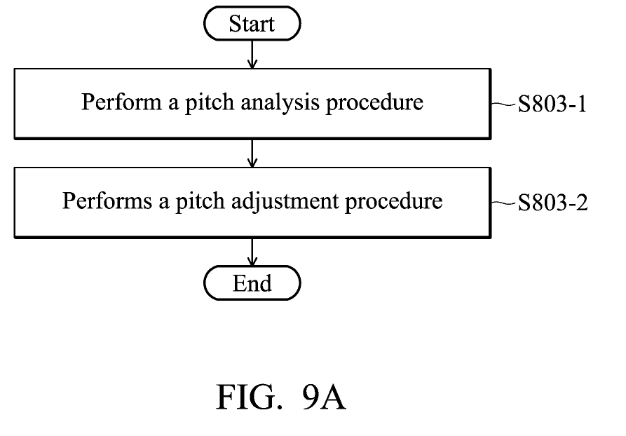

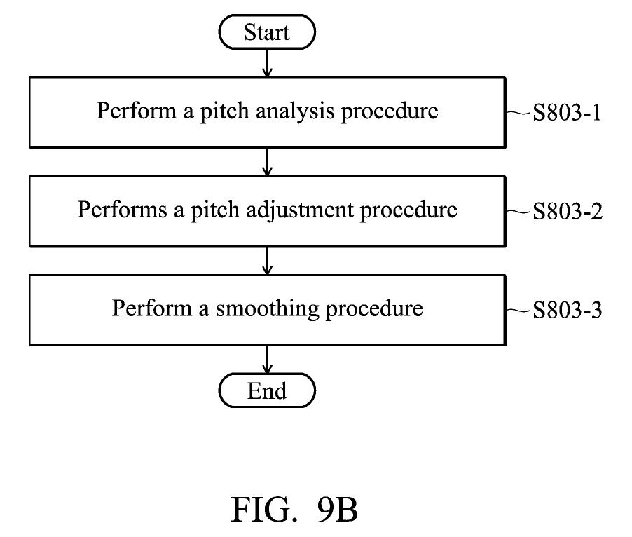

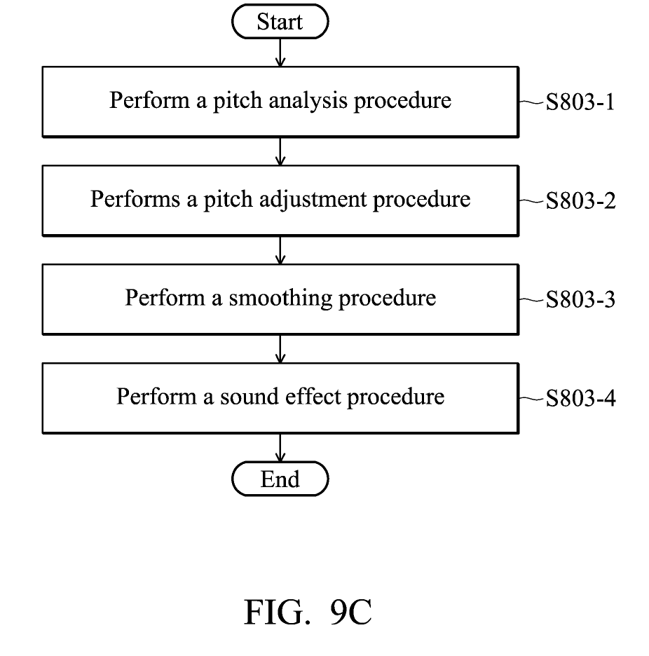

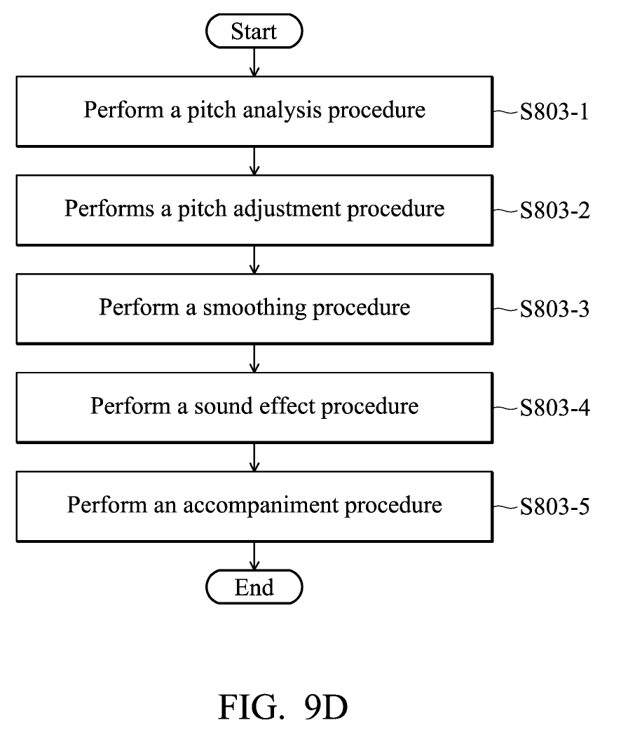

As shown in FIG. 9A, the processing of the original voice signals in step S803 may further include the following sub-steps. At first, the electronic computing device performs a pitch analysis procedure on the original voice signals (step S803-1) to obtain a plurality of same pitches by the pitch tracking, pitch marking, and pitches flatting techniques. Next, the electronic computing device performs a pitch adjustment procedure on the same pitches (step S803-2). The pitch adjustment procedure may use the PSOLA method, the Cross-fadding method, or the Resample method to adjust each of the same pitches to its standard pitch indicated by the tune of the selected song, to obtain the adjusted voice signals. The detailed operation of the PSOLA method, the Cross-Fadding method, and the Resample method are illustrated in FIGS. 4, 5, and 6A and 6B, respectively.

In some embodiments, after the pitch analysis procedure and the pitch adjustment procedure, the singing voice synthesis method, as shown in FIG. 9B, may continue with performing a smoothing procedure on the adjusted voice signals (step S803-3). The smoothing procedure may use linear interpolation, bilinear interpolation, or polynomial interpolation, to smoothly concatenate the adjusted voice signals to obtain a smoothed voice signal. The detailed operation of the polynomial interpolation is illustrated in FIG. 7A˜7C.

In some embodiments, after the pitch analysis procedure, the pitch adjustment procedure, and the smoothing procedure, the singing voice synthesis method, as shown in FIG. 9C, may continue with performing a sound effect procedure on the smoothed voice signal (step S803-4). The sound effect procedure may first determine the size of the sampling frame to the smoothed voice signal based on the loading of the electronic computing device. Then, the sound effect procedure adjusts the volume and adds vibrato and echo effects to the smoothed voice signal one according to the sampling frame, and consequently, generates a sound-effected voice signal.

In some embodiments, the singing voice synthesis method, as shown in FIG. 9D, may further perform an accompaniment procedure on one of the adjusted voice signals, the smoothed voice signal, and the sound-effected voice signal (step S803-5). The accompaniment procedure combines one of the adjusted voice signals, the smoothed voice signal, and the sound-effected voice signal, with the accompaniment of the selected song to generate an accompanied voice signal to be output. It is noted that each of the previously mentioned adjusted voice signals, smoothed voice signal, sound-effected voice signal, and accompanied voice signal may be the presentation of a synthesized singing voice signal of the present invention.

The electronic computing device implementing the singing voice synthesis method may be a desktop computer, a laptop, a mobile communication device, an electronic toy, or an electronic pet. Moreover, the electronic computing device may include a song database storing tunes of popular songs for the user to select and synthesize with their personalized singing voice. The song database may also store the lyrics of the songs and the corresponding rhythms.

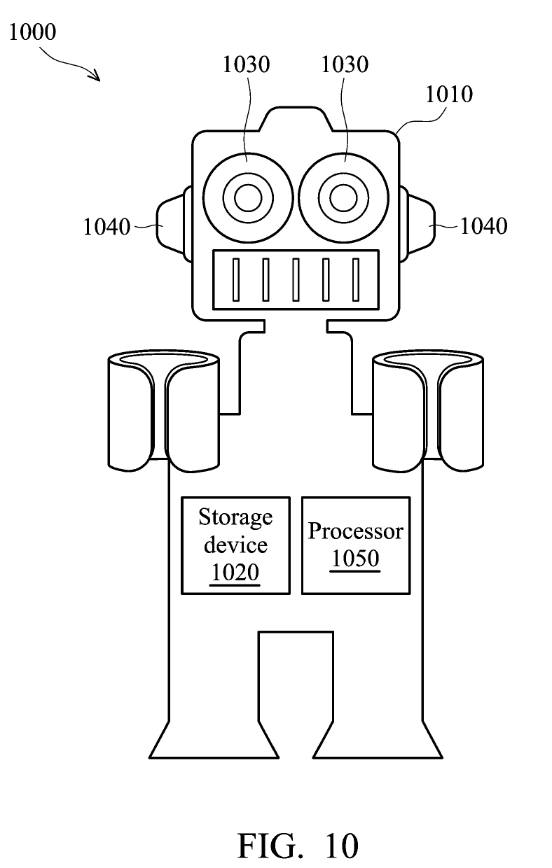

FIG. 10 is a diagram illustrating the system architecture of the singing voice synthesis apparatus in accordance with an embodiment of the present invention. In this embodiment, the singing voice synthesis apparatus 1000 is an electronic toy. While in other embodiments, the singing voice synthesis apparatus 1000 may be a desktop computer, a laptop, a mobile communication device, a handheld digital device, a personal digital assistant (PDA), an electronic pet, a robot, a voice recorder, or a digital music player. The singing voice synthesis apparatus 1000 includes at least an exterior case 1010, a storage device 1020, a tempo means 1030, an audio receiver 1040, and a processor 1050. The storage device 1020, installed inside of the exterior case 1010 and connected to the processor 1050, stores a plurality of tunes of songs and provides the tunes to the tempo means 1030. The tempo means 1030, installed outside of the exterior case 1010 and connected to the processor 1050, provides a set of tempo cues in accordance with a selected tune to assist the user in reading lyrics aloud or singing the lyrics. The audio receiver 1040, installed outside of the exterior case 1010 and connected to the processor 1050, receives a plurality of original voice signals generated from the reading or singing of the user. The processor 1050, installed inside of the exterior case, processes the original voice signals and generates a synthesized singing voice signal according to the selected tune.

As shown in FIG. 10, the storage device 1020 may be a Random Access Memory, such as: Flash memory, Read-Only Memory (ROM), Cache, etc., installed in the trunk-area of the electronic toy, and the tunes stored may be MIDI files. The tempo means 1030 may be a light emitter installed in the eye-area of the electronic toy, for generating flashes and color changing lights. When implemented, the light emitter may use the LED (Light-emitting diode) or other light generating components. The tempo means 1030 may be a movable machinery, installed in the hand-area of the electronic toy, for providing actions, such as: swinging, rotating, leaping, or like the waving axis of a piano metronome. The tempo means 1030 may be a display, installed in the abdominal region of the electronic toy, for displaying visual signals, such as moving symbols, flashing symbols, leaping dots, or color-changing patterns, etc. The tempo means 1030 may be an audio speaker, installed in the mouth-area of the electronic toy, for outputting sounds like the ticking of a metronome. The audio receiver 1040 is a component, such as a microphone, a tone collector, or a recorder, for receiving sounds, and it may be installed in the ear-area of the electronic toy. It is noted that the original voice signals correspond to the selected tune and matches the tempo cues.

The processor 1050 may be an embedded micro-processor including any other necessary components to support the functions thereof. The processor 1050 may be installed in the trunk-area of the electronic toy. The processor 1050 is connected to the storage device 1020, the tempo means 1030, and the audio receiver 1040. The processor 1050 mainly processes the original voice signals according to the selected tune and generates a synthesized singing voice signal. In some embodiments, the processing includes flatting the pitches of the original voice signals to obtain a plurality of same pitches, and adjusting each of the same pitches to its standard pitch indicated by the selected tune to obtain a plurality of adjusted voice signals. Further, the processor 1050 may perform a smoothing procedure on the adjusted voice signals to generate a smoothed voice signal.

In other embodiments, the processor 1050 may perform a pitch analysis procedure to obtain the plurality of same pitches by the pitch tracking, pitch marking, and pitches flatting techniques. The processor 1050 continues its procedure, by performing a pitch adjustment procedure on the same pitches to adjust each of the same pitches to its standard pitch indicated by the selected tune, by using the PSOLOA method, the Cross-fadding method, or the Resample method. The detailed operation of the PSOLA method, the Cross-Fadding method, and the Resample method are illustrated in FIGS. 4, 5, and 6A and 6B, respectively. Subsequently, the processor 1050 performs a smoothing procedure, using the linear interpolation, the bilinear interpolation, or the polynomial interpolation, to smoothly concatenate the adjusted voice signals and obtain a smoothed voice signal. The detail operation of the polynomial interpolation is illustrated in FIG. 7A˜7C.

In other embodiments, the processor 1050 may further perform a sound effect procedure on the smoothed voice signal. The sound effect procedure first determines the size of the sampling frame to the smoothed voice signal based on the loading of the singing voice synthesis apparatus 1000. Then, the sound effect procedure continues with adjusting the volume and adding vibrato and echo effects to the smoothed voice signal according to the sampling frame, and consequently, a sound-effected voice signal is obtained. In other embodiments, the processor 1050 may perform an accompaniment procedure on one of the adjusted voice signals, the smoothed voice signal, and the sound-effected voice signal. The accompaniment procedure combines one of the adjusted voice signals, the smoothed voice signal, and the sound-effected voice signal, with the accompaniment of the selected song and generates an accompanied voice signal. It is noted that each of the previously mentioned adjusted voice signals, smoothed voice signal, sound-effected voice signal, and accompanied voice signal may be the presentation of a synthesized singing voice signal of the present invention. In addition, the synthesized singing voice signal contains the tone of the user.

In some embodiments, the singing voice synthesis apparatus 1000 may further include an audio speaker (not shown), installed outside of the exterior case 1010 and connected to the processor 1050, for outputting of the synthesized singing voice signal. As shown in FIG. 10, the audio speaker may be a megaphone, an earphone, an amplifier, or other sound broadcasting components. Furthermore, when outputting the synthesized singing voice signal, the singing voice synthesis apparatus 1000 may show the corresponding tempo. The tempo shown may be actions, such as swinging, rotating, or leaping, provided by the movable machinery, or visual signs, such as moving symbols, flashing symbols, leaping dots, or color-changing patterns generated by the display, or sounds like the ticking of a metronome.

In order to make sure the established rhythm pattern of the original voice signals is at an acceptable level, the processor 1050 may further determine whether the established rhythm pattern exceeds a default error threshold value. If the established rhythm pattern exceeds the default error threshold value, the processor 1050 prompts the user to regenerate the original voice signals and the receiving of the original voice signals is repeated. The detailed operation of determining the established rhythm pattern is depicted in FIG. 3. Meanwhile, in other embodiments, the processor 1050 may instruct the audio speaker to output the original voice signals for the user to listen to and determine whether the original voice signals are acceptable. If the original voice signals are not acceptable, the user may regenerate the original voice signals. In either embodiments, the user may generate the original voice signals by reading lyrics aloud or singing the lyrics, or the user may input a plurality of voice signals which are recorded or processed in advance.

In the previously mentioned embodiments, the original voice signals are generated by the user reading or singing based on the selected tune and the tempo cues. Each original voice signal corresponds to each note of the selected tune and each tempo cue, respectively, so that the original voice signals are ready to be processed without word segmentation. The conventional singing voice synthesis system requires the corpus database to be established and this requirement usually takes up much time and cost. When compared to the conventional singing voice synthesis system, the present invention does not need to establish a corpus database; and thus, less system resources are required and better results are obtained when considering required time and quality. Most importantly, the synthesized singing voice signal contains the tone of the user, and is more fluent and natural sounding.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A singing voice synthesis system, comprising:
a storage unit, storing at least one tune;
a tempo unit, providing a set of tempo cues in accordance with a selected tune from the at least one tune;
an input unit, receiving a plurality of original voice signals corresponding to the selected tune; and
a processing unit, processing the original voice signals and generating a synthesized singing voice signal according to the selected tune.

2. The singing voice synthesis system of claim 1, wherein the original voice signals are generated by a user based on the set of tempo cues and lyrics corresponding to the selected tune, and each of the original voice signals respectively corresponds to each word of the lyrics.

3. The singing voice synthesis system of claim 1, wherein the original voice signals are in an established rhythm pattern, and the singing voice synthesis system further comprises a rhythm analysis unit determining whether the established rhythm pattern exceeds a default error threshold value.

4. The singing voice synthesis system of claim 1, wherein processing of the original voice signals comprises:
performing a pitch analysis procedure and a pitch adjustment procedure to obtain a plurality of adjusted voice signals as the synthesized singing voice signal,
wherein the pitch analysis procedure obtains a plurality of pitches respectively corresponding to the original voice signals by a pitch tracking technique, and then the pitches are flatted to a specific pitch level.

5. The singing voice synthesis system of claim 4, wherein processing of the original voice signals further comprises:
performing a smoothing procedure on the adjusted voice signals to obtain a smoothed voice signal as the synthesized singing voice signal.

6. The singing voice synthesis system of claim 5, wherein processing of the original voice signals further comprises:
performing a sound effect procedure on the smoothed voice signal to obtain a sound-effected voice signal as the synthesized singing voice signal.

7. The singing voice synthesis system of claim 6, wherein processing of the original voice signals further comprises:
performing an accompaniment procedure on one of the adjusted voice signals, the smoothed voice signal, and the sound-effected voice, to obtain an accompanied voice signal as the synthesized singing voice signal.

8. A singing voice synthesis method for an electronic computing device with an audio receiver and an audio speaker, comprising:
providing a set of tempo cues in accordance with a selected tune from the at least one tune;
receiving, via the audio receiver, a plurality of original voice signals corresponding to the selected tune;
processing the original voice signals according to the selected tune and outputting, via the audio speaker, a synthesized singing voice signal.

9. A singing voice synthesis method of claim 8, wherein the original voice signals are in an established rhythm pattern and are generated by a user based on the set of tempo cues and lyrics corresponding to the selected tune, and the singing voice synthesis method further comprises determining whether the established rhythm pattern exceeds a default error threshold value, and repeating the step of receiving the original voice signals if the established rhythm pattern exceeds the default error threshold value.

10. The singing voice synthesis method of claim 8, wherein processing of the original voice signals comprises:
performing a pitch analysis procedure and a pitch adjustment procedure to obtain a plurality of adjusted voice signals as the synthesized singing voice signal,
wherein the pitch analysis procedure obtains a plurality of pitches respectively corresponding to the original voice signals by a pitch tracking technique, and then the pitches are flatted to a specific pitch level.

11. The singing voice synthesis method of claim 10, wherein processing of the original voice signals further comprises:
performing a smoothing procedure on the adjusted voice signals to obtain a smoothed voice signal as the synthesized singing voice signal.

12. The singing voice synthesis method of claim 11, wherein processing of the original voice signals further comprises:
performing a sound effect procedure on the smoothed voice signal to obtain a sound-effected voice signal as the synthesized singing voice signal.

13. The singing voice synthesis method of claim 12, wherein processing of the original voice signals further comprises:
performing an accompaniment procedure on one of the adjusted voice signals, the smoothed voice signal, and the sound-effected voice, to obtain an accompanied voice signal as the synthesized singing voice signal.

14. A singing voice synthesis apparatus, comprising an exterior case, a storage device, a tempo means, an audio receiver, and a processor, wherein
the storage device, installed inside of the exterior case and connected to the processor, stores at least one tune;
the tempo means, installed outside of the exterior case and connected to the processor, provides a set of tempo cues in accordance with a selected tune from the at least one tune;
the audio receiver, installed outside of the exterior case and connected to the processor, receives a plurality of original voice signals corresponding to the selected tune; and
the processor, installed inside of the exterior case, processes the original voice signals and generates a synthesized singing voice signal according to the selected tune.

15. The singing voice synthesis apparatus of claim 14, wherein the storage device is a Random Access Memory, the tempo means is a digital flashing device, a movable machinery, a display device, or an audio speaker, the audio receiver is a microphone, a tone collector, or a recorder, and the processor is an embedded micro-processor.

16. The singing voice synthesis apparatus of claim 14, wherein the original voice signals are in an established rhythm pattern and are generated by a user based on the set of tempo cues and lyrics corresponding to the selected tune, and the processor further determines whether the established rhythm pattern exceeds a default error threshold value, and prompts the user to regenerate the original voice signals if the established rhythm pattern exceeds the default error threshold value.

17. The singing voice synthesis apparatus of claim 14, wherein processing of the original voice signals comprises:
performing a pitch analysis procedure and a pitch adjustment procedure to obtain a plurality of adjusted voice signals as the synthesized singing voice signal,
wherein the pitch analysis procedure obtains a plurality of pitches respectively corresponding to the original voice signals by a pitch tracking technique, and then the pitches are flatted to a specific pitch level.

18. The singing voice synthesis apparatus of claim 17, wherein processing of the original voice signals further comprises:
performing a smoothing procedure on the adjusted voice signals to obtain a smoothed voice signal as the synthesized singing voice signal.

19. The singing voice synthesis apparatus of claim 18, wherein processing of the original voice signals further comprises:
performing a sound effect procedure on the smoothed voice signal to obtain a sound-effected voice signal as the synthesized singing voice signal.

20. The singing voice synthesis apparatus of claim 19, wherein processing of the original voice signals further comprises:
performing an accompaniment procedure on one of the adjusted voice signals, the smoothed voice signal, and the sound-effected voice, to obtain an accompanied voice signal as the synthesized singing voice signal.

21. The singing voice synthesis apparatus of claim 14, further comprising:
an audio speaker, outputting the synthesized singing voice signal.
